(19) United States
(12) Patent Application Publication
(10) Pub. No.: US 2025/0323706 A1
(43) Pub. Date: Oct. 16, 2025

(54) ANTENNA QUANTITY CONTROL METHOD, COMMUNICATION DEVICE, AND MEDIUM

(71) Applicant: REALME CHONGQING MOBILE TELECOMMUNICATIONS CORP., LTD., Chongqing (CN)

(72) Inventor: Yuchun LUO, Chongqing (CN)

(73) Assignee: REALME CHONGQING MOBILE TELECOMMUNICATIONS CORP., LTD., Chongqing (CN)

(21) Appl. No.: 19/249,977

(22) Filed: Jun. 25, 2025

Related U.S. Application Data
(63) Continuation of application No. PCT/CN2023/122908, filed on Sep. 28, 2023.

(30) Foreign Application Priority Data
Dec. 30, 2022 (CN) 202211726719.4

(51) Int. Cl. H04B 7/06; H04B 7/0413

(52) U.S. Cl. CPC H04B 7/0693; H04B 7/0413

(57) ABSTRACT

The present application relates to an antenna quantity control method, a communication device, and a medium. The method is applied to a first communication device. The method includes: obtaining communication quality information of a current communication with a second communication device; and adjusting a quantity of antennas participating in the communication according to the communication quality information. The quantity of antennas participating in the communication is negatively correlated with communication quality represented by the communication quality information.

### CROSS REFERENCE TO RELATED APPLICATIONS

The present disclosure is a continuation of International Patent Application No. PCT/CN2023/122908, filed Sep. 28, 2023, which claims priority to Chinese Patent Application No. 202211726719.4, filed Dec. 30, 2022, the entire contents of these applications are incorporated herein by reference.

### TECHNICAL FIELD

The present disclosure relates to the field of mobile communication technologies, and in particular to an antenna quantity control method, a communication device, and a non-transitory computer-readable storage medium.

### BACKGROUND

With the rapid development of mobile communication technologies, more and more terminals support multiple-input multiple-output (MIMO) function. A MIMO technology uses multiple transmitting antennas and multiple receiving antennas at a transmitting end and a receiving end respectively to transmit and receive signals.

When a terminal supports the MIMO function, multi-antenna transmission and reception of the terminal can certainly improve communication quality, but it will increase the power consumption of the terminal. Therefore, how to achieve a balance between communication quality and terminal power consumption has become an urgent problem to solve.

### SUMMARY

In a first aspect, the present disclosure provides an antenna quantity control method, applied to a first communication device. The method includes: obtaining communication quality information of a current communication with a second communication device; and adjusting a quantity of antennas participating in the communication according to the communication quality information. The quantity of antennas participating in the communication is negatively correlated with communication quality represented by the communication quality information.

In a second aspect, the present disclosure provides a communication device including a memory and a processor. The memory is configured to store a computer program, and the computer program is configured to be executed by the processor to achieve the antenna quantity control method according to the first aspect.

In a third aspect, the present disclosure provides a non-transitory computer-readable storage medium configured to store a computer program. The computer program is configured to be executed by a processor to achieve the antenna quantity control method according to the first aspect.

### BRIEF DESCRIPTION OF THE DRAWINGS

In order to more clearly illustrate the technical solutions in the embodiments of the present disclosure or the related art, the drawings in the description needed to be used in the embodiments or the related art are briefly introduced below. Obviously, the drawings in the description are only some embodiments of the present disclosure. For those of ordinary skilled in the art, other drawings may also be obtained based on the drawings without creative work.

FIG. 1 is a schematic implementation environment diagram of an antenna quantity control method according to some embodiments of the present disclosure.

FIG. 2 is a flow chart of an antenna quantity control method according to some embodiments of the present disclosure.

FIG. 3 is a flow chart of block 202 according to some embodiments of the present disclosure.

FIG. 4 is a flow chart of block 301 according to some embodiments of the present disclosure.

FIG. 5 is a flow chart of block 302 according to some embodiments of the present disclosure.

FIG. 6 is another flow chart of block 302 according to some embodiments of the present disclosure.

FIG. 7 is another flow chart of an antenna quantity control method according to some embodiments of the present disclosure.

FIG. 8 is further another flow chart of an antenna quantity control method according to some embodiments of the present disclosure.

FIG. 9 is a structural block diagram of an antenna quantity control apparatus according to some embodiments of the present disclosure.

FIG. 10 is an internal structure diagram of a communication device according to some embodiments of the present disclosure.

FIG. 11 is another internal structure diagram of a communication device according to some embodiments of the present disclosure.

### DETAILED DESCRIPTION

In order to make the purposes, technical solutions, and advantages of the present disclosure more clearly understood, the present disclosure is further described in detail below in conjunction with the accompanying drawings and embodiments. The specific embodiments described herein are only used to explain the present disclosure and are not used to limit the present disclosure.

An implementation environment involved in an antenna quantity control method provided in the embodiments of the present disclosure is briefly described below.

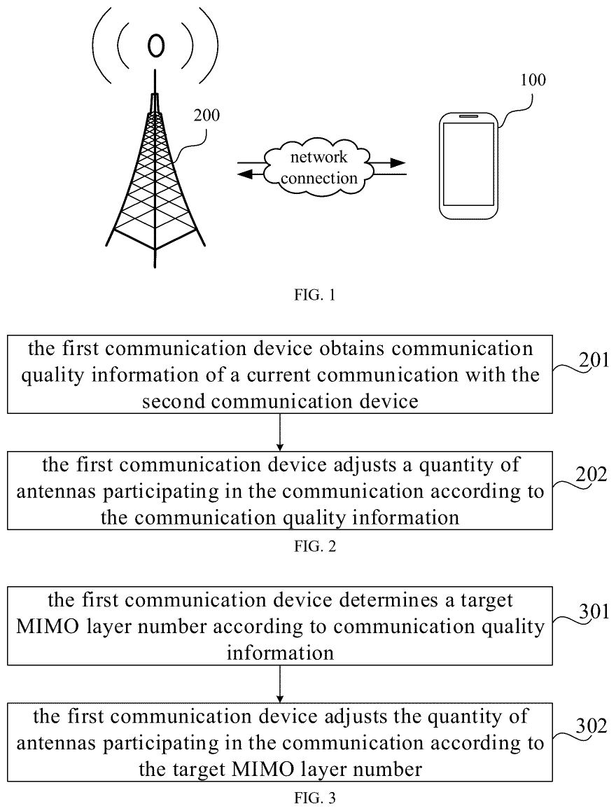

In some embodiments, as shown in FIG. 1, the implementation environment may include a terminal 100 and a base station 200. The terminal 100 and the base station 200 may communicate through a network.

The terminal 100 may include a personal digital assistant (PDA), a handheld device with wireless communication function, a computing device or other processing device connected to a wireless modem, a vehicle-mounted device, a wearable device, a user device in a 5G network or a user device in a future evolved public land mobile network (PLMN), etc. The base station 200 may be any type of base station device such as a macro base station, a micro base station, or a pico base station.

In some embodiments, a first communication device may be the terminal 100 shown in FIG. 1, and a second communication device may be the base station 200 shown in FIG. 1.

In some other embodiments, the first communication device may be the base station 200 shown in FIG. 1, and the second communication device may be the terminal 100 shown in FIG. 1.

An execution subject of the antenna quantity control method provided in the embodiments of the present disclosure may be an antenna quantity control apparatus. The antenna quantity control apparatus may be implemented as part or all of the first communication device through software, hardware, or a combination of software and hardware. In the following method embodiments, the execution subject is exemplified by the first communication device.

In some embodiments, as shown in FIG. 2, the antenna quantity control method is provided. The method is described by taking the application of the method to the first communication device as an example. The method may include the operations executed by the following blocks.

At block 201, the first communication device obtains communication quality information of a current communication with the second communication device.

The communication quality information may include a block error rate in a current communication process in a case where the first communication device communicates with the second communication device. The block error rate (BLER) refers to an error probability of a transmission block after a cyclic redundancy check (CRC), and is a ratio of erroneous blocks to a total number of received blocks. The block error rate may provide intuitive feedback on the communication quality of the current communication process.

In some embodiments, the communication quality information may also include a bit error rate in the current communication process. The implementations of the communication quality information are not limited here.

During the communication with the second communication device, the first communication device may obtain the block error rate in the current communication process. As described above, the first communication device may be a terminal, and the second communication device may be a base station. The first communication device may be a base station, and the second communication device may be a terminal. The communication process may be a downlink communication process (i.e., the base station sends communication data to the terminal) or an uplink communication process (i.e., the terminal sends communication data to the base station).

In the following, taking the case where the communication quality information includes the block error rate and the current communication process is a downlink communication process as an example, embodiments of block 201 are introduced in two cases according to different device roles of the first communication device and the second communication device.

In some embodiments, the first communication device is a terminal, and the second communication device is a base station. During a communication process between the terminal and the base station, i.e., during a process in which the terminal, as a receiving end, receives communication data sent by the base station, the block error rate in the current communication process is obtained.

In some embodiments, within a sliding time window T1, each time the terminal receives communication data sent by the base station, the terminal performs a CRC check to obtain a CRC check result. According to each CRC check result, the terminal divides a pass number of CRC checks by a total number of CRC checks to obtain the block error rate in the current communication process. The sliding time window T1 may be any time period during the current communication process, for example, may be a historical time period including a current moment.

In some other embodiments, the first communication device is a base station, and the second communication device is a terminal. During a communication process between the base station and the terminal, i.e., during a process in which the base station, as a transmitting end, sends communication data to the terminal, the block error rate in the current communication process is obtained.

In some other embodiments, within a sliding time window T1, each time the terminal receives communication data sent by the base station, the terminal performs a CRC check to obtain a CRC check result. The terminal feeds back the CRC check result to the base station through hybrid automatic repeat request (HARQ). After the base station receives the HARQ, according to each CRC check result, the base station divides a pass number of CRC checks by a total number of CRC checks to obtain the block error rate in the current communication process.

In this way, through the above embodiments, the first communication device may obtain the communication quality information of the current communication with the second communication device.

At block 202, the first communication device adjusts a quantity of antennas participating in the communication according to the communication quality information.

The communication quality information may accurately feedback communication quality of the current communication process. The first communication device adjusts the quantity of antennas participating in the communication of the communication device (e.g., the first communication device or the second communication device) according to the communication quality information. The quantity of antennas participating in the communication is negatively correlated with the communication quality represented by the communication quality information.

Continuing with the example of communication quality information including the block error rate, the larger the block error rate, the lower the communication quality. In a case where the block error rate is large, it means that the communication quality is poor at this time. Therefore, the quantity of antennas participating in the communication may be increased to enhance the robustness of data transmission, thereby improving the communication quality. For example, the same data may be transmitted on each antenna participating in the communication, and the receiving end may perform combination and decoding after receiving the data sent by each antenna, thereby increasing the decoding success rate.

In a case where the block error rate is small, it means that the communication quality is good at this time. Therefore, the quantity of antennas participating in the communication may be reduced to achieve the purpose of saving the power consumption of the communication device.

In this way, in a case where the first communication device is a terminal, the first communication device adjusts the quantity of antennas of the first communication device participating in the communication according to the communication quality information through the above-mentioned embodiments. For example, the quantity of antennas participating in the communication may be increased or decreased by shutting down a radio frequency link. In a case where the first communication device is a base station, the first communication device adjusts the quantity of antennas of the second communication device (i.e., a terminal) participating in the communication according to the communication quality information through the above-mentioned embodiments. For example, the quantity of antennas of the second communication device participating in the communication may be adjusted by sending instructions to the second communication device, and so on.

The above embodiments are based on the current communication process being a downlink communication process. In some embodiments, the communication process may be an uplink communication process, or the communication process may be a downlink communication process and an uplink communication process, which are not limited here. For the terminal, whether the terminal is a transmitting end or a receiving end, the reduction in the quantity of antennas involved in the communication may reduce the power consumption of the terminal. In a case where the terminal is a transmitting end, there is a corresponding relationship between the radio frequency link and an antenna panel. Reducing a group of antennas reduces the power consumption of a corresponding radio frequency link. The radio frequency link includes a power amplifier, and the power consumption of the power amplifier accounts for a relatively large proportion. In a case where the terminal is a receiving end, shutting down the radio frequency link saves energy.

In some embodiments, for the antenna quantity control method of the embodiments of the present disclosure, the first communication device may synchronously apply the antenna quantity control method to the downlink communication process and the uplink communication process. Alternatively, the first communication device may apply the antenna quantity control method to the downlink communication process, and for the uplink communication process, based on a principle of channel reciprocity, reuse the quantity of antennas participating in the communication after adjustment in the downlink communication process. Alternatively, the first communication device may apply the antenna quantity control method to the uplink communication process, and for the downlink communication process, reuse the quantity of antennas participating in the communication after adjustment in the uplink communication process.

In general, in the above-mentioned embodiments, the first communication device obtains the communication quality information of the current communication with the second communication device, and adjusts the quantity of antennas participating in the communication according to the communication quality information. The quantity of antennas participating in the communication is negatively correlated with the communication quality represented by the communication quality information. In this way, the embodiments of the present disclosure dynamically adjust the quantity of antennas participating in the communication in the communication device (e.g., the first communication device or the second communication device) according to the communication quality information. When the communication quality represented by the communication quality information is relatively high, the quantity of antennas participating in the communication may be reduced, thereby reducing the power consumption of the communication device. When the communication quality represented by the communication quality information is relatively low, the quantity of antennas participating in the communication may be increased, thereby improving the communication quality. In this way, a balance between the communication quality and the power consumption of the communication device may be achieved.

At present, in a case where a terminal accesses a base station, the terminal may report supported capabilities, including whether the terminal supports receiving or transmitting via multiple antennas. Usually, the base station may fully consider the performance requirements and generally perform scheduling according to a maximum quantity of antennas of the terminal, which leads to high power consumption of the terminal. In the embodiments of the present disclosure, the quantity of antennas participating in the communication in the terminal may be dynamically adjusted according to the communication quality information, which is conducive to reducing the power consumption of the terminal.

In some embodiments, based on the embodiments shown in FIG. 2, as shown in FIG. 3, the embodiments relate to a process of how the first communication device adjusts the quantity of antennas participating in the communication according to the communication quality information. As shown in FIG. 3, the block 202 includes block 301 and block 302.

At block 301, the first communication device determines a target MIMO layer number according to communication quality information.

The multiple-input multiple-output (MIMO) layer refers to receiving and transmitting channels of communication data. Taking 2*2 MIMO as an example, the 2*2 MIMO represents that a transmitting end uses two antennas to transmit signals, and a receiving end uses two antennas to receive signals. There are two receiving and transmitting channels for communication data, that is, a MIMO layer number is 2 layers.

It can be seen that, although the MIMO layer number is not equal to the quantity of antennas participating in the communication (new radio (NR) technology allows one MIMO layer to be mapped to multiple antennas), there is a fixed mapping relationship between the quantity of antennas participating in the communication of a communication device and the MIMO layer number. Therefore, the quantity of antennas participating in the communication of a communication device may be adjusted according to the MIMO layer number.

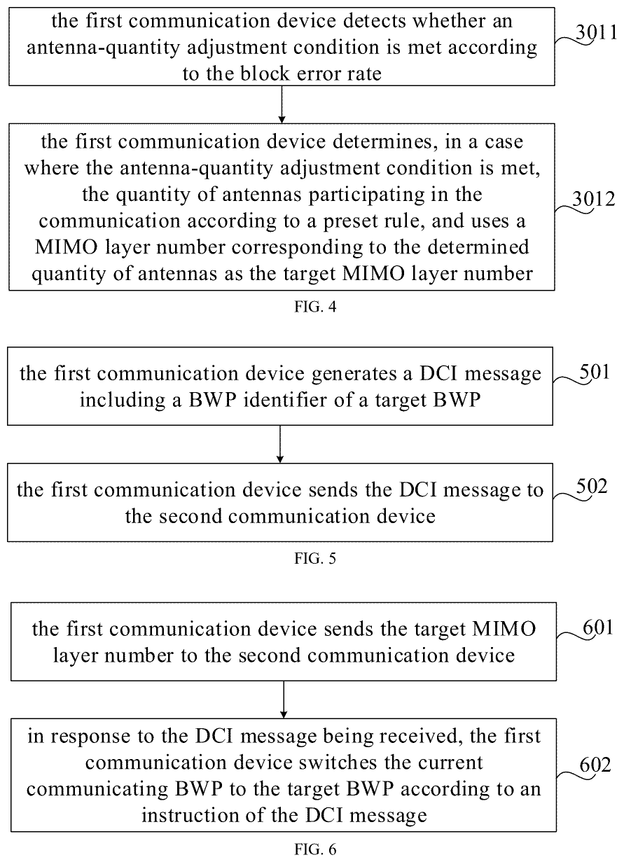

In some embodiments of block 301, the communication quality information includes the block error rate. As shown in FIG. 4, block 301 may include block 3011 and block 3012 shown in FIG. 4.

At block 3011, the first communication device detects whether an antenna-quantity adjustment condition is met according to the block error rate.

The antenna-quantity adjustment condition includes that the block error rate is less than a first threshold, or that the block error rate is greater than a second threshold.

In the embodiments of the present disclosure, the first threshold and the second threshold for the block error rate may be preset. The second threshold is greater than or equal to the first threshold. The first threshold and the second threshold may be manually set.

In a case where the block error rate is less than the first threshold, it means that the block error rate is relatively small and the communication quality is relatively good. Therefore, the quantity of antennas participating in the communication may be reduced, that is, the block error rate meets the antenna-quantity adjustment condition.

In a case where the block error rate is greater than the second threshold, it means that the block error rate is relatively large and the communication quality is relatively poor. Therefore, the quantity of antennas participating in the communication may be increased, that is, the block error rate also meets the antenna-quantity adjustment condition.

At block 3012, the first communication device determines, in a case where the antenna-quantity adjustment condition is met, the quantity of antennas participating in the communication according to a preset rule, and uses a MIMO layer number corresponding to the determined quantity of antennas as the target MIMO layer number.

The preset rule may be set as required during implementation. For example, the preset rule may be that a quantity of antennas to be increased/reduced is 1/N of the quantity of antennas currently participating in the communication. The N is an integer greater than 1 and may be set during implementation.

After the first communication device determines the quantity of antennas participating in the communication according to the preset rule (it can be understood that the quantity of antennas participating in the communication is a target value for adjusting the quantity of antennas, that is, the quantity of antennas participating in the communication of the communication device requires to be adjusted to the target value), the first communication device determines the MIMO layer number corresponding to the quantity of antennas participating in the communication determined by the first communication device according to the preset rule according to the mapping relationship between the quantity of antennas participating in the communication and the MIMO layer number, thereby obtaining the target MIMO layer number.

The above embodiments are only described by taking the antenna-quantity adjustment condition including the block error rate being less than the first threshold or the block error rate being greater than the second threshold as an example. The antenna-quantity adjustment condition may be determined in combination with other factors. Several exemplary implementation methods of the antenna-quantity adjustment condition are introduced below.

In some embodiments, the antenna-quantity adjustment condition further includes that a time difference between a current moment and a moment when the quantity of antennas participating in the communication was last adjusted is greater than a preset time difference threshold.

In some embodiments, in a case where the first communication device detects whether the antenna-quantity adjustment condition is met according to the block error rate, the first communication device may obtain a moment when the quantity of antennas participating in the communication was last adjusted, calculate the time difference between the current moment and the moment when the quantity of antennas participating in the communication was last adjusted, and detect whether the time difference is greater than the preset time difference threshold.

In a case where the time difference is less than the preset time difference threshold, it indicates that the time since the quantity of antennas was last adjusted is relatively close. In order to avoid frequent switching of the antennas used, the first communication device determines that the antenna-quantity adjustment condition is not met, thereby ensuring that the quantity of antennas participating in the communication does not change within a certain period of time, and ensuring communication stability.

In a case where the time difference is greater than the preset time difference threshold, it indicates that the time since the quantity of antennas was last adjusted is far away. At this time, in a case where the block error rate is less than the first threshold or the block error rate is greater than the second threshold, the first communication device determines that the antenna-quantity adjustment condition is met.

In some embodiments, in a case where the antenna-quantity adjustment condition includes the block error rate less than the first threshold, the antenna-quantity adjustment condition further includes that the quantity of antennas currently participating in the communication is greater than 1. In a case where the antenna-quantity adjustment condition includes the block error rate greater than the second threshold, the antenna-quantity adjustment condition further includes that the quantity of antennas currently participating in the communication is less than a total quantity of antennas.

In a case where the antenna-quantity adjustment condition includes the block error rate less than the first threshold, and in a case where the block error rate is less than the first threshold, it means that the block error rate is relatively small and the communication quality is relatively good at this time. The quantity of antennas participating in the communication may be reduced. Therefore, the quantity of antennas currently participating in the communication must be greater than 1, so that a process of reducing the quantity of antennas participating in the communication may be smoothly implemented. In this way, it is ensured that at least one antenna is configured for transmitting and receiving communication data after the reduction.

In a case where the antenna-quantity adjustment condition includes the block error rate greater than the second threshold, and in a case where the block error rate is greater than the second threshold, it means that the block error rate is relatively large and the communication quality is relatively poor at this time. The quantity of antennas participating in the communication may be increased. Therefore, the current quantity of antennas currently participating in the communication is less than the total quantity of antennas. In this way, a process of increasing the quantity of antennas participating in the communication may be smoothly implemented, that is, the quantity of antennas after increased may be ensured not to exceed the total quantity of antennas of the communication device.

In some other embodiments, the antenna-quantity adjustment condition may be determined in combination with whether the terminal triggers energy-saving requirements, the current transmission power of the terminal, a scheduled coding modulation method, etc., and the possible embodiments of the antenna-quantity adjustment condition are not limited here.

In some other embodiments of block 301, the communication quality information also includes the block error rate, and a prediction model may be trained in advance. The prediction model is configured to realize a mapping of the block error rate and the MIMO layer number. The first communication device inputs the obtained block error rate currently communicating with the second communication device into the prediction model, and obtains the target MIMO layer number output by the prediction model.

In this way, through the above-mentioned embodiments, the first communication device determines the target MIMO layer number according to the communication quality information.

At block 302, the first communication device adjusts the quantity of antennas participating in the communication according to the target MIMO layer number.

As described above, there is the fixed mapping relationship between the quantity of antennas participating in the communication of the communication device and the MIMO layer number. The energy-saving effect of changing the MIMO layer number is the same as the energy-saving effect of directly changing the quantity of antennas participating in the communication. According to this principle, the first communication device adjusts the quantity of antennas participating in the communication according to the target MIMO layer number.

During a mobile communication process, the base station (e.g., the first communication device or the second communication device in the embodiments of the present disclosure) will configure different maximum MIMO layers for each bandwidth part (BWP) respectively, and different maximum MIMO layers correspond to different quantities of antennas participating in the communication. In this way, according to the above-mentioned target MIMO layer numbers, it is possible to determine the target MIMO layer number as a target BWP of the maximum MIMO layer number. The target BWP is switched for communication, thereby realizing the change of the MIMO layer number by switching the BWP.

The followings are illustrative introductions to the embodiments of block 302 in two cases with respect to different device roles of the first communication device.

In some embodiments, as shown in FIG. 5, the first communication device is a base station, and block 302 may include block 501 and block 502 shown in FIG. 5.

At block 501, the first communication device generates a DCI message including a BWP identifier of a target BWP.

The target MIMO layer number is a maximum MIMO layer number corresponding to the target BWP.

In a case where the first communication device is a base station, since the base station configures a different maximum MIMO layer number for each BWP, the first communication device determines the target MIMO layer number as the target BWP of the maximum MIMO layer number, and then guides the terminal (i.e., the second communication device) to switch to the target BWP.

The first communication device may trigger BWP switching through a DCI message to achieve dynamic MIMO layer number switching. In some embodiments, in DCI0-1 and DCI1-1, there is a bandwidth part indicator field. In a case where the first communication device generates a DCI message, the BWP identifier of the target BWP may be added to the field to obtain the DCI message.

At block 502, the first communication device sends the DCI message to the second communication device.

The DCI message is configured to instruct the second communication device to switch from a current communicating BWP to the target BWP.

In this way, during uplink scheduling and downlink scheduling, the second communication device may determine the target BWP that requires to be switched by identifying the bandwidth part indicator field in the DCI message, and switch to the target BWP. In this way the purpose of adjusting the quantity of antennas participating in the communication of the second communication device to a quantity of antennas corresponding to the target BWP may be achieved.

In some other embodiments, as shown in FIG. 6, the first communication device is a terminal, and block 302 may include block 601 and block 602 shown in FIG. 6.

At block 601, the first communication device sends the target MIMO layer number to the second communication device.

The target MIMO layer number is configured to request the second communication device to return a DCI message.

When implemented on the terminal side, the first communication device acts as a terminal. If the quantity of antennas participating in the communication requires to be adjusted, the user equipment (UE) auxiliary information is sent to the base station (i.e., the second communication device). The UE auxiliary information may only include the target MIMO layer number. The UE auxiliary information may of course also be other information, and the other information carries the target MIMO layer number.

The first communication device informs the base station of an expected maximum MIMO layer number (i.e., the target MIMO layer number) through the UE auxiliary information. After receiving the UE auxiliary information, the base station sends the DCI message to the first communication device. The DCI message is configured to instruct the first communication device to switch from the current communicating BWP to the target BWP. The target MIMO layer number is the maximum MIMO layer number corresponding to the target BWP.

At block 602, in response to the DCI message being received, the first communication device switches the current communicating BWP to the target BWP according to an instruction of the DCI message.

In this way, after the first communication device receives the DCI message, the first communication device switches from the current communicating BWP to the target BWP according to the instruction of the DCI message, thereby adjusting the quantity of antennas participating in the communication of the first communication device to the quantity of antennas corresponding to the target BWP.

The above embodiments dynamically adjust the quantity of antennas participating in the communication in the terminal according to the communication quality information by switching BWP, thereby dynamically adjusting the quantity of antennas participating in the communication, and may achieve a balance between block error rate and terminal energy consumption. The entire process relies on a related technical framework, and there is no need to add new interfaces or modify protocols, which reduces the difficulty of implementation.

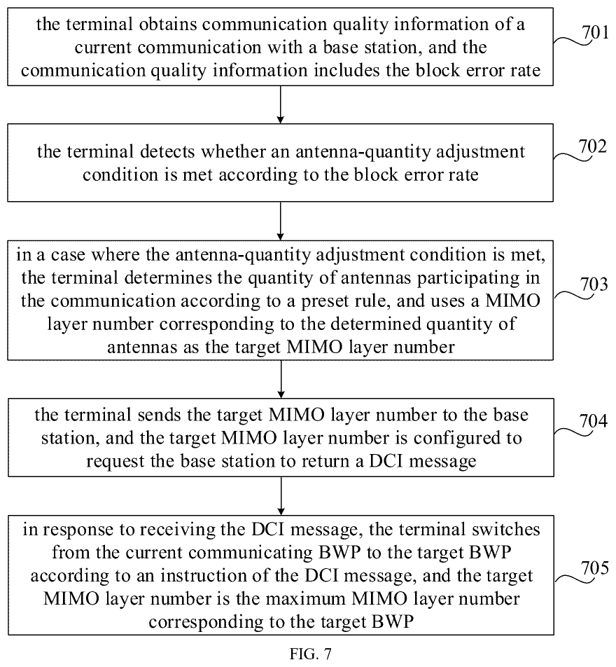

In some embodiments, as shown in FIG. 7, an antenna quantity control method, applied to a terminal, is provided. The method may include the operations executed by the following blocks.

At block 701, the terminal obtains communication quality information of a current communication with a base station. The communication quality information includes the block error rate.

At block 702, the terminal detects whether an antenna-quantity adjustment condition is met according to the block error rate.

The antenna-quantity adjustment condition includes that the block error rate is less than a first threshold, or that the block error rate is greater than a second threshold.

In some embodiments, the antenna-quantity adjustment condition includes that a time difference between a current moment and a moment when the quantity of antennas participating in the communication was last adjusted is greater than a preset time difference threshold.

In some embodiments, in a case where the antenna-quantity adjustment condition includes the block error rate less than the first threshold, the antenna-quantity adjustment condition further includes that the quantity of antennas of the terminal currently participating in the communication is greater than 1. In a case where the antenna-quantity adjustment condition includes the block error rate greater than the second threshold, the antenna-quantity adjustment condition further includes that the quantity of antennas of the terminal currently participating in the communication is less than a total quantity of terminal antennas.

At block 703, in a case where the antenna-quantity adjustment condition is met, the terminal determines the quantity of antennas participating in the communication according to a preset rule, and uses a MIMO layer number corresponding to the determined quantity of antennas as the target MIMO layer number.

At block 704, the terminal sends the target MIMO layer number to the base station. The target MIMO layer number is configured to request the base station to return a DCI message.

At block 705, in response to receiving the DCI message, the terminal switches from the current communicating BWP to the target BWP according to an instruction of the DCI message. The target MIMO layer number is the maximum MIMO layer number corresponding to the target BWP.

The quantity of antennas participating in the communication is negatively correlated with the communication quality represented by the communication quality information.

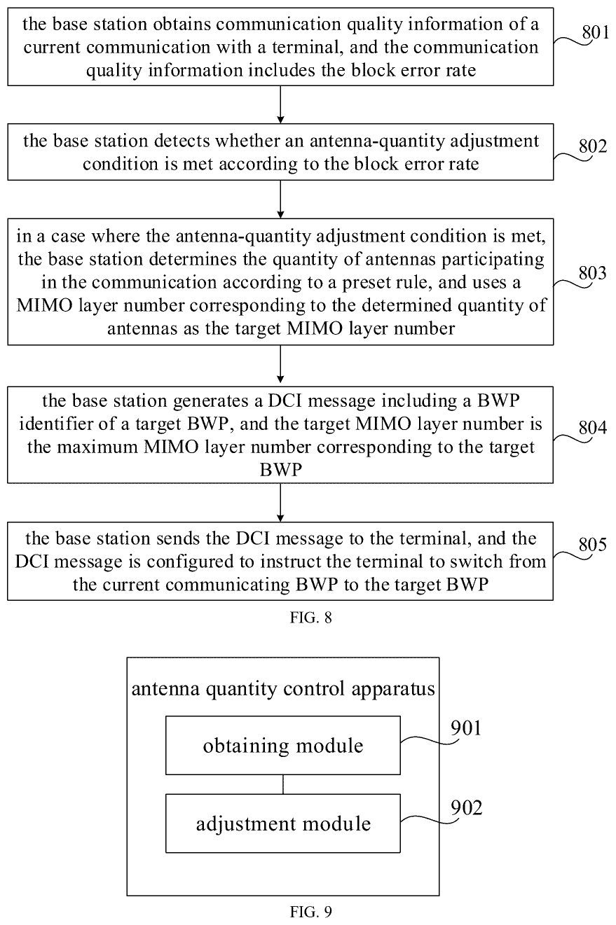

In some embodiments, as shown in FIG. 8, an antenna quantity control method, applied to a base station, is provided. The method may include the operations executed by the following blocks.

At block 801, the base station obtains communication quality information of a current communication with a terminal. The communication quality information includes the block error rate.

At block 802, the base station detects whether an antenna-quantity adjustment condition is met according to the block error rate.

The antenna-quantity adjustment condition includes that the block error rate is less than a first threshold, or that the block error rate is greater than a second threshold.

In some embodiments, the antenna-quantity adjustment condition includes that a time difference between a current moment and a moment when the quantity of antennas participating in the communication was last adjusted is greater than a preset time difference threshold.

In some embodiments, in a case where the antenna-quantity adjustment condition includes the block error rate less than the first threshold, the antenna-quantity adjustment condition further includes that the quantity of antennas of the terminal currently participating in the communication is greater than 1. In a case where the antenna-quantity adjustment condition includes the block error rate greater than the second threshold, the antenna-quantity adjustment condition further includes that the quantity of antennas of the terminal currently participating in the communication is less than a total quantity of terminal antennas.

At block 803, in a case where the antenna-quantity adjustment condition is met, the base station determines the quantity of antennas participating in the communication according to a preset rule, and uses a MIMO layer number corresponding to the determined quantity of antennas as the target MIMO layer number.

At block 804, the base station generates a DCI message including a BWP identifier of a target BWP. The target MIMO layer number is the maximum MIMO layer number corresponding to the target BWP.

At block 805, the base station sends the DCI message to the terminal. The DCI message is configured to instruct the terminal to switch from the current communicating BWP to the target BWP.

The quantity of antennas participating in the communication is negatively correlated with the communication quality represented by the communication quality information.

Although the various operations in the flowcharts involved in the above-mentioned embodiments are displayed in sequence according to the indication of the arrows, these operations are not necessarily executed in sequence according to the order indicated by the arrows. Unless there is a clear explanation in the description, the execution of these operations does not have a strict order restriction, and these operations may be executed in other orders. Moreover, at least a part of the operations in the flowcharts involved in the above-mentioned embodiments may include multiple operations or multiple stages, and these operations or stages are not necessarily executed at the same time, but may be executed at different times. The execution order of these operations or stages is not necessarily carried out in sequence, but may be executed in turn or alternately with other operations or at least a part of the operations or stages in other operations.

Based on the same inventive concept, the embodiments of the present disclosure further provide an antenna quantity control apparatus for implementing the antenna quantity control method involved above. The embodiments for solving the problem provided by the apparatus are similar to the embodiments recorded in the above method, so the specific limitations in the one or more antenna quantity control apparatus embodiments provided below may refer to the limitations of the antenna quantity control method above, and will not be repeated here.

In some embodiments, as shown in FIG. 9, an antenna quantity control apparatus is provided. The antenna quantity control apparatus is arranged in a first communication device, and includes an obtaining module 901 and an adjustment module 902.

The obtaining module 901 is configured to obtain communication quality information of a current communication with a second communication device.

The adjustment module 902 is configured to adjust a quantity of antennas participating in the communication according to the communication quality information.

The quantity of antennas participating in the communication is negatively correlated with communication quality represented by the communication quality information.

In some embodiments, the adjustment module 902 includes a determination unit and an adjustment unit.

The determination unit is configured to determine a target MIMO layer number according to the communication quality information.

The adjustment unit is configured to adjust the quantity of antennas participating in the communication according to the target MIMO layer number.

In some embodiments, the communication quality information includes a block error rate, and the determination unit is configured to detect whether an antenna-quantity adjustment condition is met according to the block error rate. The antenna-quantity adjustment condition includes that the block error rate is less than a first threshold, or that the block error rate is greater than a second threshold. In a case where the antenna-quantity adjustment condition is met, the quantity of antennas participating in the communication is determined according to a preset rule. The MIMO layer number corresponding to the determined quantity of antennas is used as the target MIMO layer number.

In some embodiments, the antenna-quantity adjustment condition includes that a time difference between a current moment and a moment when the quantity of antennas participating in the communication was last adjusted is greater than a preset time difference threshold.

In some embodiments, in a case where the antenna-quantity adjustment condition includes that the block error rate is less than the first threshold, the antenna-quantity adjustment condition further includes that the quantity of antennas currently participating in the communication is greater than 1. In a case where the antenna-quantity adjustment condition includes that the block error rate is greater than the second threshold, the antenna-quantity adjustment condition further includes that the quantity of antennas currently participating in the communication is less than a total quantity of antennas.

In some embodiments, the first communication device is a base station, and the adjustment unit is configured to generate a DCI message including a BWP identifier of a target BWP. The target MIMO layer number is the maximum MIMO layer number corresponding to the target BWP. The adjustment unit is further configured to send the DCI message to the second communication device. The DCI message is configured to instruct the second communication device to switch from a current communicating BWP to the target BWP.

In some embodiments, the first communication device is a terminal, and the adjustment unit is configured to send the target MIMO layer number to the second communication device. The target MIMO layer number is configured to request the second communication device to return a DCI message. The adjustment unit is further configured to switch, in response to the DCI message being received, a current communicating BWP to a target BWP according to an instruction of the DCI message. The target MIMO layer number is the maximum MIMO layer number corresponding to the target BWP.

Each module in the above-mentioned antenna quantity control apparatus may be implemented in whole or in part by software, hardware, or a combination thereof. Each module may be embedded in or independent of a processor in a communication device in a form of hardware, or may be stored in a memory in a communication device in a form of software, so that the processor may call and execute operations corresponding to each module above.

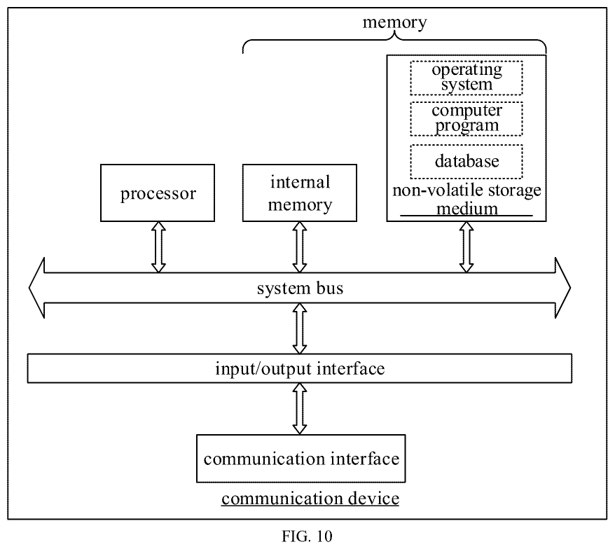

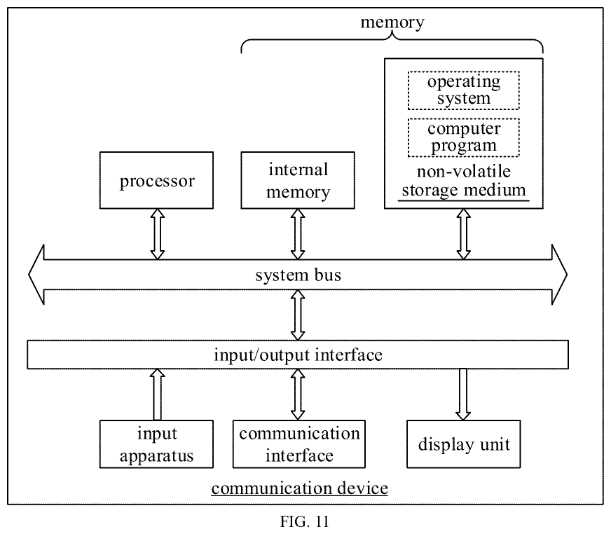

In some embodiments, a communication device is provided. The communication device may be a base station, and an internal structure diagram of the communication device may be shown in FIG. 10. The communication device includes a processor, a memory, an input/output interface (Input/Output, I/O), and a communication interface. The processor, the memory, and the input/output interface are connected via a system bus, and the communication interface is connected to the system bus via the input/output interface. The processor of the communication device is configured to provide computing and control capabilities. The memory of the communication device includes a non-volatile storage medium and an internal memory. The non-volatile storage medium is configured to store an operating system, a computer program, and a database. The internal memory provides an environment for the operation of the operating system and the computer program in the non-volatile storage medium. The database of the communication device is configured to store antenna quantity control data. The input/output interface of the communication device is configured to exchange information between the processor and an external device. The communication interface of the communication device is configured to communicate with an external terminal via a network connection. In a case where the computer program is executed by the processor, an antenna quantity control method is implemented.

In some embodiments, a communication device is provided. The communication device may be a terminal, and an internal structure diagram of the communication device may be shown in FIG. 11. The communication device includes a processor, a memory, an input/output interface, a communication interface, a display unit, and an input apparatus. The processor, the memory, and the input/output interface are connected via a system bus, and the communication interface, the display unit, and the input apparatus are connected to the system bus via the input/output interface. The processor of the communication device is configured to provide computing and control capabilities. The memory of the communication device includes a non-volatile storage medium and an internal memory. The non-volatile storage medium stores an operating system and a computer program. The internal memory provides an environment for the operation of the operating system and the computer program in the non-volatile storage medium. The input/output interface of the communication device is configured to exchange information between the processor and an external device. The communication interface of the communication device is configured to communicate with an external terminal in a wired or wireless manner. The wireless manner may be implemented through WIFI, a mobile cellular network, near field communication (NFC), or other technologies. In a case where the computer program is executed by the processor, an antenna quantity control method is implemented. The display unit of the communication device is configured to form a visually visible picture. The display unit may be a display screen, a projection apparatus, or a virtual reality imaging apparatus. The display screen may be a liquid crystal display screen or an electronic ink display screen. The input apparatus of the communication device may be a touch layer covering the display screen, may be a button, trackball, or touchpad arranged on a housing of the communication device, may also be an external keyboard, touchpad, or mouse, etc.

Those skilled in the art will understand that the structures shown in FIG. 10 and FIG. 11 are merely block diagrams of partial structures related to the embodiments of the present disclosure, and do not constitute limitations on the communication device to which the embodiments of the present disclosure are applied. The communication device may include more or fewer components than shown in the drawings, or combine certain components, or have a different arrangement of components.

The embodiments of the present disclosure further provide a computer-readable storage medium, e.g., one or more non-volatile computer-readable storage media containing computer-executable instructions. In a case where the computer-executable instructions are executed by one or more processors, the processors execute the operations of the antenna quantity control method.

The embodiments of the present disclosure further provide a computer program product including an instruction. In a case where the instruction is executed on a computer, the computer is enable to execute the antenna quantity control method.

User information (including but not limited to user device information, user personal information, etc.) and data (including but not limited to data used for analysis, stored data, displayed data, etc.) involved in the present disclosure are all information and data authorized by the user or fully authorized by all parties. The collection, use, and processing of relevant data must comply with relevant laws, regulations, and standards of relevant countries and regions.

Those of ordinary skill in the art may understand that all or part of the processes in the above-mentioned embodiment methods may be completed by instructing the relevant hardware through a computer program. The computer program may be stored in a non-volatile computer-readable storage medium. In a case where the computer program is executed, the computer program may include the processes of the embodiments of the above-mentioned methods. Any reference to the memory, database, or other medium used in the embodiments provided in the present disclosure may include at least one of non-volatile and volatile memory. The non-volatile memory may include read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM), phase change memory (PCM), graphene memory, etc. The volatile memory may include random access memory (RAM) or external cache memory, etc. As an illustration and not limitation, the RAM may be in various forms, such as static random access memory (SRAM) or dynamic random access memory (DRAM). The database involved in each embodiment provided in the present disclosure may include at least one of a relational database and a non-relational database. The non-relational databases may include distributed databases based on blockchains, etc., but are not limited thereto. The processor involved in each embodiment provided in the present disclosure may be a general-purpose processor, a central processor, a graphics processor, a digital signal processor, a programmable logic device, a data processing logic device based on quantum computing, etc., but are not limited thereto.

The technical features of the above embodiments may be arbitrarily combined. To make the description concise, not all possible combinations of the technical features in the above embodiments are described. However, as long as there is no contradiction in the combination of these technical features, they should be considered to be within the scope of this specification.

The above-described embodiments only express several embodiment methods of the present disclosure, and the descriptions thereof are relatively specific and detailed, but they cannot be understood as limiting the scope of the present disclosure. For those of ordinary skill in the art, several variations and improvements may be made without departing from the concept of the present disclosure, and these all belong to the protection scope of the present disclosure. Therefore, the protection scope of the present disclosure shall be subject to the attached claims.

1. An antenna quantity control method, applied to a first communication device, and comprising:
obtaining communication quality information of a current communication with a second communication device; and
adjusting a quantity of antennas participating in the communication according to the communication quality information;
wherein the quantity of antennas participating in the communication is negatively correlated with communication quality represented by the communication quality information.

2. The antenna quantity control method according to claim 1, wherein the adjusting a quantity of antennas participating in the communication according to the communication quality information, comprises:
determining a target multiple-input multiple-output (MIMO) layer number according to the communication quality information; and
adjusting the quantity of antennas participating in the communication according to the target MIMO layer number.

3. The antenna quantity control method according to claim 2, wherein the communication quality information comprises a block error rate, and the determining the determining a target MIMO layer number according to the communication quality information, comprises:
detecting whether an antenna-quantity adjustment condition is met according to the block error rate, wherein the antenna-quantity adjustment condition comprises that the block error rate is less than a first threshold, or that the block error rate is greater than a second threshold; and
determining, in a case where the antenna-quantity adjustment condition is met, the quantity of antennas participating in the communication according to a preset rule, and using a MIMO layer number corresponding to the determined quantity of antennas as the target MIMO layer number.

4. The antenna quantity control method according to claim 3, wherein the antenna-quantity adjustment condition further comprises that a time difference between a current moment and a moment when the quantity of antennas participating in the communication was last adjusted is greater than a preset time difference threshold.

5. The antenna quantity control method according to claim 3, wherein in a case where the antenna-quantity adjustment condition comprises that the block error rate is less than the first threshold, the antenna-quantity adjustment condition further comprises that the quantity of antennas currently participating in the communication is greater than 1;
in a case where the antenna-quantity adjustment condition comprises that the block error rate is greater than the second threshold, the antenna-quantity adjustment condition further comprises that the quantity of antennas currently participating in the communication is less than a total quantity of antennas.

6. The antenna quantity control method according to claim 2, wherein the first communication device is a base station, and the adjusting the quantity of antennas participating in the communication according to the target MIMO layer number, comprises:
generating a downlink control information (DCI) message comprising a bandwidth part (BWP) identifier of a target BWP, wherein the target MIMO layer number is a maximum MIMO layer number corresponding to the target BWP; and
sending the DCI message to the second communication device, wherein the DCI message is configured to instruct the second communication device to switch from a current communicating BWP to the target BWP.

7. The antenna quantity control method according to claim 2, wherein the first communication device is a terminal, and the adjusting the quantity of antennas participating in the communication according to the target MIMO layer number, comprises:
sending the target MIMO layer number to the second communication device, wherein the target MIMO layer number is configured to request the second communication device to return a DCI message; and
switching, in response to the DCI message being received, a current communicating BWP to a target BWP according to an instruction of the DCI message, wherein the target MIMO layer number is a maximum MIMO layer number corresponding to the target BWP.

8. The antenna quantity control method according to claim 1, wherein the communication quality information comprises communication quality information in a current communication process in a case where the first communication device communicates with the second communication device;
the current communication process is a downlink communication process, or the current communication process is an uplink communication process.

9. The antenna quantity control method according to claim 8, wherein in a case where the current communication process is a downlink communication process, the method further comprises:
reusing the quantity of antennas participating in the communication after adjustment in the downlink communication process during the uplink communication process.

10. The antenna quantity control method according to claim 8, wherein in a case where the current communication process is an uplink communication process, the method further comprises:
reusing the quantity of antennas participating in the communication adjusted in the uplink communication process during the downlink communication process.

11. The antenna quantity control method according to claim 1, wherein the communication quality information comprises a bit error rate during a communication process.

12. A communication device, comprising a memory and a processor, wherein the memory is configured to store a computer program, the computer program is configured to be executed by the processor, enabling the processor to execute an antenna quantity control method, and the method is applied to a first communication device, and comprises:
obtaining communication quality information of a current communication with a second communication device; and
adjusting a quantity of antennas participating in the communication according to the communication quality information;
wherein the quantity of antennas participating in the communication is negatively correlated with communication quality represented by the communication quality information.

13. The communication device according to claim 12, wherein the adjusting a quantity of antennas participating in the communication according to the communication quality information, comprises:
determining a target multiple-input multiple-output (MIMO) layer number according to the communication quality information; and
adjusting the quantity of antennas participating in the communication according to the target MIMO layer number.

14. The communication device according to claim 13, wherein the communication quality information comprises a block error rate, and the determining the determining a target MIMO layer number according to the communication quality information, comprises:
detecting whether an antenna-quantity adjustment condition is met according to the block error rate, wherein the antenna-quantity adjustment condition comprises that the block error rate is less than a first threshold, or that the block error rate is greater than a second threshold; and
determining, in a case where the antenna-quantity adjustment condition is met, the quantity of antennas participating in the communication according to a preset rule, and using a MIMO layer number corresponding to the determined quantity of antennas as the target MIMO layer number.

15. The communication device according to claim 14, wherein the antenna-quantity adjustment condition further comprises that a time difference between a current moment and a moment when the quantity of antennas participating in the communication was last adjusted is greater than a preset time difference threshold.

16. The communication device according to claim 14, wherein in a case where the antenna-quantity adjustment condition comprises that the block error rate is less than the first threshold, the antenna-quantity adjustment condition further comprises that the quantity of antennas currently participating in the communication is greater than 1;
in a case where the antenna-quantity adjustment condition comprises that the block error rate is greater than the second threshold, the antenna-quantity adjustment condition further comprises that the quantity of antennas currently participating in the communication is less than a total quantity of antennas.

17. The communication device according to claim 13, wherein the first communication device is a base station, and the adjusting the quantity of antennas participating in the communication according to the target MIMO layer number, comprises:
generating a downlink control information (DCI) message comprising a bandwidth part (BWP) identifier of a target BWP, wherein the target MIMO layer number is a maximum MIMO layer number corresponding to the target BWP; and
sending the DCI message to the second communication device, wherein the DCI message is configured to instruct the second communication device to switch from a current communicating BWP to the target BWP.

18. The communication device according to claim 13, wherein the first communication device is a terminal, and the adjusting the quantity of antennas participating in the communication according to the target MIMO layer number, comprises:
sending the target MIMO layer number to the second communication device, wherein the target MIMO layer number is configured to request the second communication device to return a DCI message; and
switching, in response to the DCI message being received, a current communicating BWP to a target BWP according to an instruction of the DCI message, wherein the target MIMO layer number is a maximum MIMO layer number corresponding to the target BWP.

19. The communication device according to claim 12, wherein the communication quality information comprises a bit error rate during a communication process.

20. A non-transitory computer-readable storage medium, configured to store a computer program, wherein the computer program is configured to be executed by a processor to execute an antenna quantity control method, and the method is applied to a first communication device, and comprises:
obtaining communication quality information of a current communication with a second communication device; and
adjusting a quantity of antennas participating in the communication according to the communication quality information;
wherein the quantity of antennas participating in the communication is negatively correlated with communication quality represented by the communication quality information.
